(19) United States
(12) Patent Application Publication
(10) Pub. No.: US 2008/0168013 A1
(43) Pub. Date: Jul. 10, 2008

(54) Scalable pattern recognition system

(76) Inventor: Paul Cadaret, Rancho Santa Margarita, CA (US)

Correspondence Address: CROCKETT & CROCKETT, 24012 CALLE DE LA PLATA, SUITE 400, LAGUNA HILLS, CA, 92653, US

(21) Appl. No.: 11/999,430

(22) Filed: Dec. 5, 2007

Related U.S. Application Data
(60) Provisional application No. 60/873,430, filed on Dec. 5, 2006.

(51) Int. Cl. G06N 3/08

(52) U.S. Cl. 706/20

(57) ABSTRACT

An efficient method of searching large databases for pattern recognition is provided. The techniques disclosed illustrate how a large database of arbitrary binary data might be searched at high speed using fuzzy pattern recognition methods. Pattern recognition speed enhancements are derived from a strategy utilizing effective computational decomposition, multiple processing units, effective time-slot utilization, and an organizational approach that provides a method of performance improvement through effective aggregation. In a preferred technique, a pattern recognition system would utilize multiple processing units to achieve an almost arbitrarily scalable level of pattern recognition processing performance.

### RELATED APPLICATIONS

This application claims priority from copending U.S. provisional patent application 60/873,430 filed Dec. 5, 2006.

### FIELD OF THE INVENTIONS

The innovations described below relate to the field of pattern recognition systems and more specifically to pattern recognition systems that incorporate reconfigurable and computationally intensive algorithms that are used to search extremely large databases.

### BACKGROUND OF THE INVENTIONS

Modern society increasingly depends on the ability to effectively recognize patterns in data. New discoveries in science are often based on recognizing patterns in experimentally acquired data. New discoveries in medicine are often based on recognizing patterns of behavior in the human body. The inspiration for a new life-saving pharmaceutical product might be based on recognizing patterns in complex molecular structures. Financial institutions look for patterns of behavior that provide the telltale signs of credit card fraud. Airport screening systems look for patterns in sensor data that indicate the presence of weapons or dangerous substances. The need for pattern recognition in our daily lives is so broad that we generally take it for granted.

The human brain has the awesome ability to quickly recognize various types of data patterns. Through our eyes our brain receives a constant stream of two-dimensional images through which we can recognize a vast array of visual patterns. It is common for people to have the ability to quickly recognize the faces of family, friends, and a myriad of acquaintances. We can generally recognize the difference between a dog, a cat, a car, and a broad array of other visual patterns. Through our ears our brain receives a constant stream of time-sequential data and through this data stream we can generally recognize individual voices, language, birds chirping, music, mechanical sounds, and a broad array of other audio patterns. These abilities are so common for most of us that we don't often consider their complexity.

As we consider the extremely broad array of patterns that the human brain is capable of recognizing we realize that there must be a tremendously large database being searched at any point in time. This implies that any attempt to emulate the pattern recognition behavior of the human brain will likely require effective methods to search vast pattern recognition databases.

Various methods exist to search for patterns in data. A commercial relational database system might simply perform an exact comparison of one data field with another and repeat this type of operation thousands or even millions of times during a single transaction. Numerous software algorithms exist that allow various types of data patterns to be compared. Most of these algorithms are special-purpose in nature and they are effective in only a small problem domain.

Artificial neural networks (hereafter called neural networks (NN)) represent a category of pattern recognition algorithms that can recognize somewhat broader patterns in arbitrary data. These algorithms provide a means to recognize patterns in data using an imprecise or fuzzy pattern recognition strategy. The ability to perform fuzzy pattern recognition is important because it provides the framework for pattern recognition generalization. Through generalization a single learned pattern might be applied to a variety of future situations. As an example, if a friend calls on the telephone we generally recognize their voice whether we hear them in person, hear them on our home phone, or hear them on a cell phone in a noisy restaurant. The human brain has the remarkable ability to generalize previously learned patterns and recognize those patterns even when they significantly deviate from the originally learned data pattern. The point we draw from this is that the ability to perform fuzzy pattern recognition is apparently inherent in human pattern recognition processes.

Unfortunately, fuzzy pattern recognition algorithms like those used in artificial neural networks are significantly more computationally expensive to perform. Each pattern recognition operation might be an order of magnitude or more computationally expensive than a simple precise data set comparison operation. This appears to be the price that must be paid for generalization. If we now consider the computational burden that is incurred when a pattern recognition engine must search a vast database of stored patterns, we can see that emulating the pattern recognition behavior of the human brain can be a daunting computational task.

The effectiveness of a pattern recognition system is largely a function of accuracy and speed. A pattern recognition system that is inaccurate is generally of little value. Pattern recognition systems that are accurate but very slow will likely find very limited application. This implies a need for pattern recognition systems that have the potential to be as accurate as needed while maintaining high pattern recognition rates. Given that the human brain has the apparent capability to employ vast pattern recognition databases we conclude that effective artificial pattern recognition systems might also require such large databases as well. The challenge then becomes how to perform computationally intensive processes on large pattern recognition databases while maintaining high processing speeds. Methods by which such processing can be performed are the subject of this disclosure.

Prior artificial neural network devices have largely focused on implementing a particular algorithm at high-speed in some fixed hardware configuration. An example of such a device is the IBM Zero Instruction Set Computer (ZISC). These devices implemented a small array of radial basis function (RBF) ‘like’ neurons where each neuron was capable of processing a relatively small feature vector of 64 byte-wide integer values. Although such devices were quite fast (˜300 kHx) they were rather limited in their application because of their fixed neuron structure and their inability to significantly scale. These characteristics generally limit the ability of such devices to solve highly complex problems. However, these devices were pioneering in their time, they have been used to demonstrate the utility of neural network pattern recognition systems in certain domains, and they highlighted the need for greater flexibility and greater scalability in defining neural network structures.

### SUMMARY OF THE INVENTIONS

A scalable pattern recognition system that incorporates modern memory devices (RAM, FLASH, etc.) as the basis for the generation of high-performance computational results is described. Certain classes of computations are very regular in nature and lend themselves to the use of precomputed values to achieve desired results. If the precomputed values could be stored in large memory devices, accessed at high-speed, and used as the basis for some or all of the needed computational results, then great computational performance improvements could be attained. The methods described show how memory devices can be used to construct high-performance computational systems of varying complexity.

High-performance pattern recognition systems and more specifically high-performance neural network based pattern recognition systems are used to illustrate the computational methods disclosed. The use of large modern memory devices enables pattern recognition systems to be created that can search vast arrays of previously stored patterns. A scalable pattern recognition system enables large memory devices to be transformed through external hardware into high-performance pattern recognition engines and high-performance generalized computational systems. A pattern recognition engine constructed using the methods disclosed can exploit the significant speed of modern memory devices. Such processing schemes are envisioned where computational steps are performed near or above the speed at which data can be accessed from individual memory devices.

Typically, when pattern recognition software running on modern processors attempts to search vast arrays of patterns these systems are generally limited in their application by the extensive computational burden involved in such a processing approach. The computational burden generally grows rapidly with the size of the pattern search database increases and can quickly cause such systems to be rather slow. Often, such systems are too slow to be useful. The methods disclosed allow pattern recognition engines to be created that are capable of searching vast pattern databases at high speed. Such systems are capable of pattern recognition performance that is generally far beyond the speed of equivalent software-based solutions, even when such solutions employ large clusters of conventional modern processors.

A scalable pattern recognition system also contemplates the application of pattern recognition systems that are very complex in nature. An example of such a system might be a multilevel ensemble neural network computing system. Such systems might be applied to problems that mimic certain complex processes of the human brain or provide highly nonlinear machine control functions. The pattern recognition system also contemplates the need for neural network architectural innovations that can be applied to make such systems more transparent and hence more debuggable by humans. Therefore, the present system also presents methods related to an audited neuron and an audited neural network. The methods disclosed allow complex ensemble neural network solutions to be created in such a way that humans can more effectively understand unexpected results that are generated and take action to correct the network.

An efficient method of searching large databases for pattern recognition is provided. The techniques disclosed illustrate how a large database of arbitrary binary data might be searched at high speed using fuzzy pattern recognition methods. Pattern recognition speed enhancements are derived from a strategy utilizing effective computational decomposition, multiple processing units, effective time-slot utilization, and an organizational approach that provides a method of performance improvement through effective aggregation. In a preferred technique, a pattern recognition system would utilize multiple processing units to achieve an almost arbitrarily scalable level of pattern recognition processing performance.

### BRIEF DESCRIPTION OF THE DRAWINGS

FIG. 1 is a block diagram of a simple printed character recognition system might be created through the use of a page-scanner, a neural network pattern recognition subsystem, and an output device; all components are orchestrated by a single processor.

FIG. 2 is a block diagram that shows how a two dimensional image might be scanned, data extracted from a subregion of the image, the subregion image analyzed, and a feature-vector created that can be then used to support pattern recognition operations.

FIG. 3 is a block diagram of a typical feature space map showing how a variety of feature-vectors and associated neuron influence fields might populate such a map and support pattern recognition system operation.

FIG. 4 is a block diagram representing a typical 2-dimensional (2D) radial basis function (RBF) vector distance computation that might be used to support a fuzzy pattern recognition system.

FIG. 5 is a diagram that presents a series out definitions and equations for the use of hyperdimensional feature vectors when using RBF computations to support pattern recognition system operation.

FIG. 6 is a logical block diagram of a typical weighted RBF neuron as might be used to support pattern recognition system operation.

FIG. 7 is a block diagram of a typical 2D feature space map showing how a variety of feature-vector prototypes might be searched during the course of a pattern recognition operation.

FIG. 8 is a worksheet that illustrates the computational burden typically incurred when a radial basis function pattern recognition search strategy is implemented using a series of sequential operations.

FIG. 9 is a diagram that presents a typical equation for a hyperdimensional unweighted RBF distance calculation as might be employed by a RBF pattern recognition system.

FIG. 10 is a block diagram that illustrates a typical series of sequential processing steps that might be employed to perform the computation shown in FIG. 9.

FIG. 11 is a block diagram that shows how a series of sequential processing steps can be decomposed into a series of computational clusters that can then be employed by a pattern recognition system.

FIG. 12 is a block diagram that shows an example series of computational steps can make more effective use of available computational time slots when performed by an efficient pattern recognition system.

FIG. 13 is a block diagram that shows how a series of computational steps can make more effective use of available computational time slots through cluster aggregation when performed by an efficient pattern recognition system.

FIG. 14 is a block diagram that shows how an arbitrarily long series of computational steps can make more effective use of available computational time slots when performed by an efficient computational system.

FIG. 15 is a block diagram of a pattern recognition system where a variety of different feature space vectors are provided to a neural network based pattern recognition system for processing.

FIG. 16 is a block diagram that shows how a long series of unknown feature vectors of arbitrary dimensionality might be processed by a neural network based pattern recognition system.

FIG. 17 is a block diagram of a complex ensemble neural network based pattern recognition system (or computing system).

FIG. 18 is a block diagram of an audited neural network system shown in the context of a simple pattern recognition system.

FIG. 19 is a schematic diagram of a neural network based pattern recognition subsystem that employs a pattern recognition coprocessor (PRC) system under the control of a host processor.

FIG. 20 is a block diagram of an example IO interface register set within the pattern recognition PRC of FIG. 19.

FIG. 21 is a diagram that shows how the Pattern Recognition Coprocessor (PRC) of FIG. 19 might search a pattern recognition database stored in memory.

FIG. 22 is a high-level block diagram of a multilevel pattern recognition system that employs a Distributed Processing Supervisory Controller (DPSC) and a series of subordinate pattern recognition subsystems as shown in FIG. 19.

FIG. 23 is a schematic diagram of a distributed processing supervisory controller (DPSC) that provides additional detail regarding the internal operation of an example DPSC.

FIG. 24 is a block diagram showing an example of a well-connected series of pattern recognition subsystem units as might be employed within an effective multilevel pattern recognition system.

FIG. 25 is a diagram that shows how arbitrarily complex computational operations can be decomposed and the results computed by an effective computational systems using the methods described herein.

FIG. 26 is a worksheet that roughly computes the time savings that can be realized when a radial basis function pattern recognition search system is implemented using the methods shown in FIG. 13 as compared to FIG. 8.

### DETAILED DESCRIPTION OF THE INVENTIONS

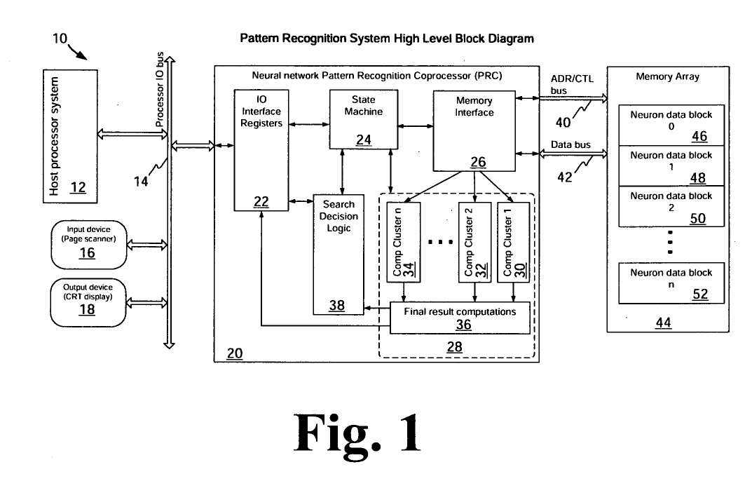

FIG. 1 shows a high-level schematic of optical character recognition system 10. Host processor 12 is shown connected to a page scanner device 16, a display device 18, and a neural network based pattern recognition coprocessor (PRC) 20 via processor I/O bus 14. Pattern recognition coprocessor 20 consists of a number of subelements that include a plurality of I/O interface registers such as interface register 22, a control state machine 24, a memory interface subsystem 26, a pattern recognition computational subsystem 28, and some pattern search decision logic 38. The pattern recognition computational subsystem 28 includes one or more computational cluster subsystems such as computational cluster subsystems 30, 32, and 34. The memory interface subsystem 26 connects to a memory array 44 via one or more address, control, and data bus elements such as bus links 40 and 42. The memory array subsystem 44 includes a series of neuron data blocks such as neuron data blocks 46, 48, 50 and 52.

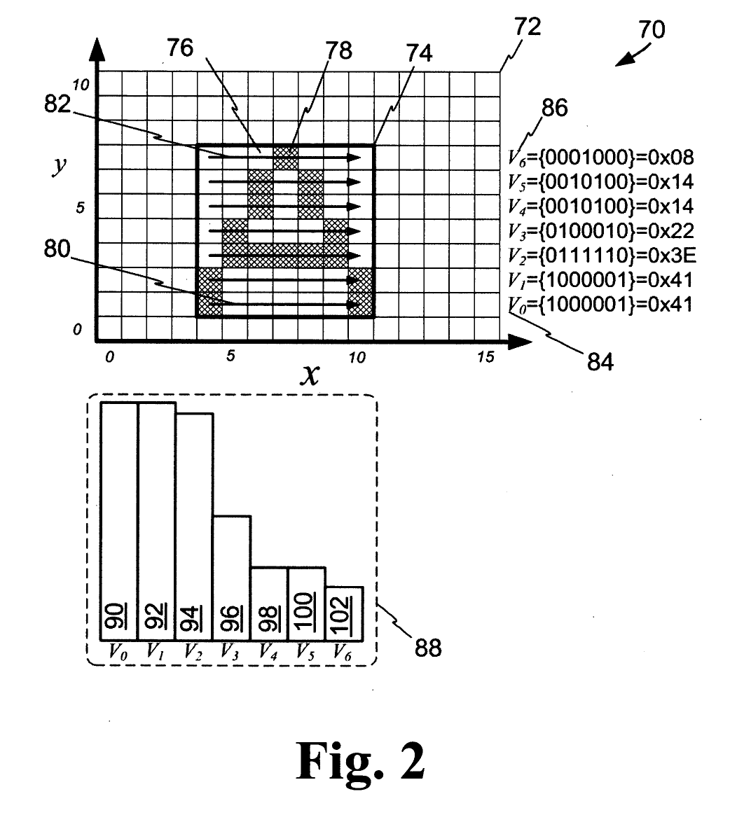

FIG. 2 shows how a region 70 of a scanned 2D image might be converted to a feature vector in support of later pattern recognition operations. A field of pixels 72 is shown to contain a subregion 74 of white 76 and black 78 pixels. The subregion of pixels 74 is shown to contain a scanned image of the letter ‘A’. During the process of feature vector formation a series of binary values is shown to be created by scanning the pixel subregion 74 from bottom to top. The row of pixels 80 through 82 representatively show how individual pixel binary values might be scanned and converted to composite integer values. The resultant feature vector elements are shown representatively as vector elements V0 through V6. The resulting feature vector as shown contains seven one-byte values. The figure further shows how the resulting feature vector might appear in the form of a bar-chart 88. This type of pictorial feature vector representation will be used in later figures. In this pictorial representation the various feature vector elements V0 through V6 are shown as graph elements 90, 92, 94, 96, 98, 100 and 102.

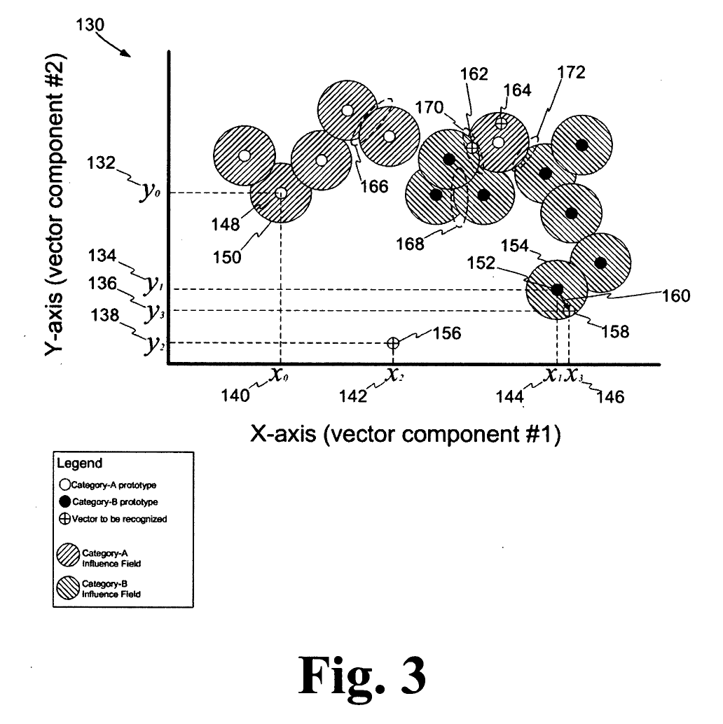

FIG. 3 shows a simple example of a 2D feature space map 130 populated with a series of prototypes and influence fields. One representative example of a prototype 148 and influence field 150 of type ‘category-A’ is shown at the coordinates [x0, Y0] (140,132). One representative example of a prototype 152 and influence field 154 of type ‘category-B’ is shown at the coordinates [X1, Y1] (144,134). One example of a vector to be recognized (or vector of interest) that is outside of a mapped region 156 is shown at the coordinates [x2, Y2] (142,138). One example of a vector to be recognized that is within a mapped region 158 is shown at the coordinates [X3, Y3] (146,136). The distance from 158 to the prototype point 152 is shown as 160. The map 130 also shows several areas of possible influence field overlap. Area 166 shows an area of ‘category-A’ overlap. Area 168 shows an area of ‘category-B’ overlap. Areas 170 and 172 show subregions where pattern recognition ambiguity might exist. Two more possible vectors to be recognized are shown as 162 and 164.

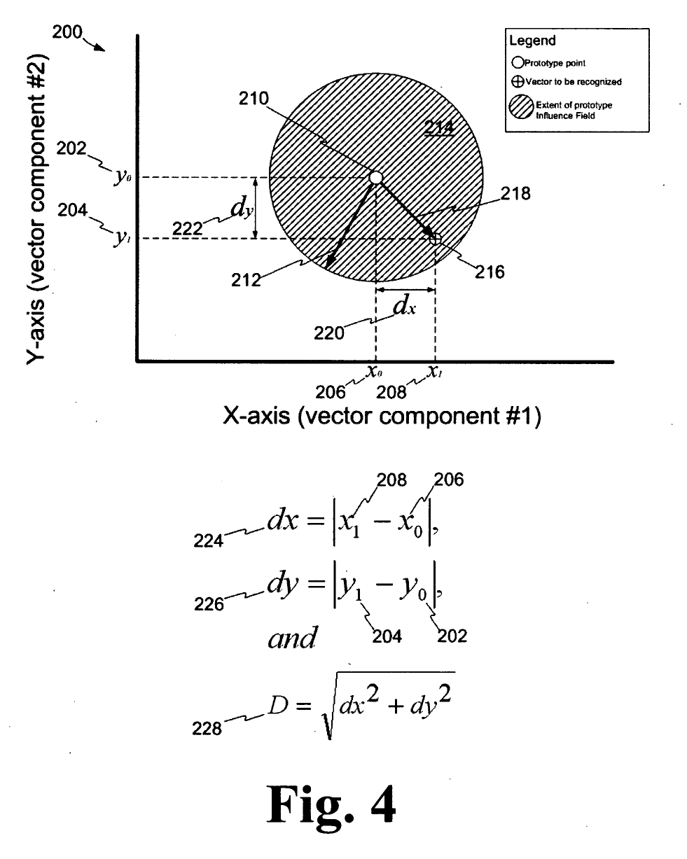

FIG. 4 shows an example of how a 2D feature space map 200 might be analyzed to determine if a vector of interest (VOI) 216 lies within the influence field of a particular prototype 210. The prototype 210 lies at the center of the influence field 214. The prototype 210 is shown at coordinates [X0, Y0] (206,202) and the VOI 216 is shown that coordinates [X1, Y1] (208,204). The extent of the influence field 214 is shown as defined by the radius 212 from the prototype 210. The radial distance from the prototype 210 to the VOI 216 is shown as 218. The X-axes offset from the prototype to the VOI is shown as 220. The Y-axes offset from the prototype to the VOI is shown as 222.

In this simple example, the radial distance can be computed using techniques from Euclidean geometry. In mathematical terms value 224 defines the formula for the X-axes offset and value 226 defines the formula for the Y-axes offset. The final result 228 defines the overall radial distance from the VOI 216 to the prototype 210. This radial distance provides a measure of similarity between the VOI and the prototype.

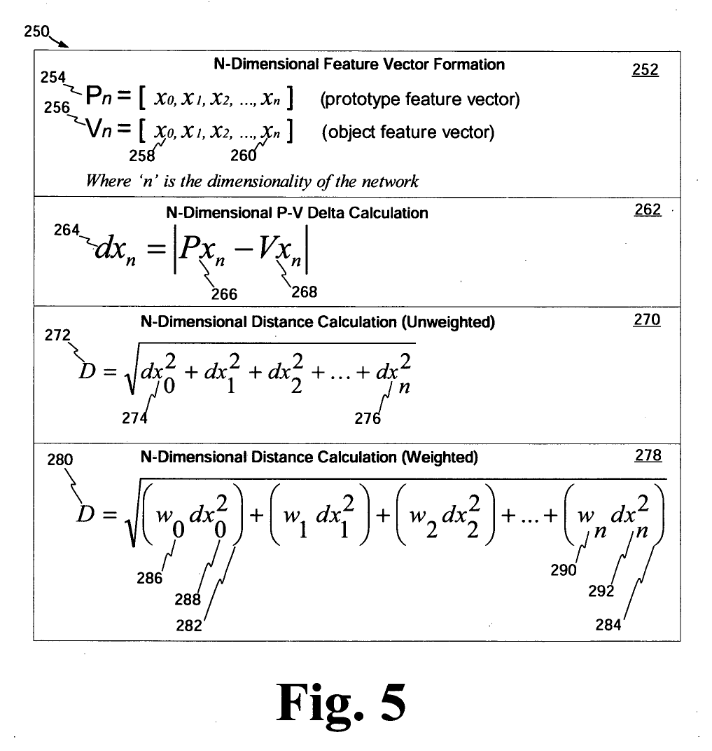

FIG. 5 provides several mathematical definitions for important values related to the formation of hyperdimensional feature vectors and their related radial distance computations 250. Block 252 defines a method of hyperdimensional feature vector formation. This block shows how a prototype point 254 might be defined from a vector of data values that ranges from X0 through Xn. Similarly, this block also shows how a VOI point 256 might be defined from a vector of data values that ranges from X0 (258) through Xn (260). Block 262 shows how a prototype to VOI offset calculation might be performed along a particular vector component axis. The resulting value dXn 264 is shown as a function of the vector components of PXn 266 and VXn 268. Block 270 provides the equation for a hyper dimensional distance calculation based on a series of unweighted vector values of dimensionality ‘n’. Because each of the vector values are unweighted the various vector values are of equal importance in the final resultant value. The resultant value ‘D’ 272 is shown to be a function of the vector values dx0 274 through dXn 276. Block 278 provides the equation for a hyper dimensional distance calculation based on a series of weighted vector values of dimensionality ‘n’. Because each of the vector values are associated with a weight-value the various vector values may be of varying importance in the final resultant value. The resultant value ‘D’ 280 is shown to be a function of the vector values ranging from dx0 to dXn (288-292) and W0 to Wn (286-290). The equation within block 278 can also be viewed as a collection of multiple to terms related to [W0, dX0] 282 through [Wn, dXn] 284.

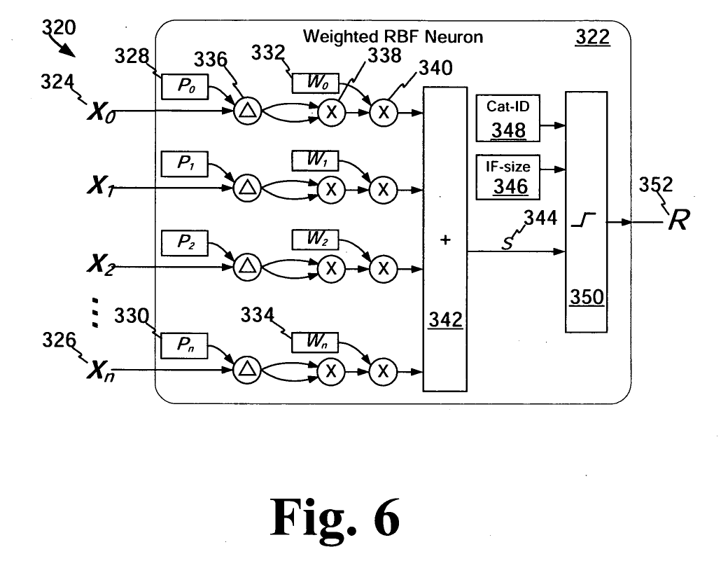

FIG. 6 is a block diagram of a weighted RBF neuron 320. The composite functional neuron 322 is shown taking a series of input vector values X0 324 through Xn 326 and generating a resultant output value R 352. To implement the equation shown in 278 the neuron 322 incorporates a series of prototype point vector component values ranging from PO 328 through Pn 330. A series of vector value difference computations is shown representatively being computed by blocks of type 336; such blocks implement the equation shown earlier as 262. The difference result from 336 is squared using the multiplication block 338. Individual vector component weight values (importance values) are shown representatively as W 332 through Wn 334. These values are then multiplied by multiplication blocks shown representatively as 340. The resulting vector values resulting from the processing of X0 324 through Xn 326 are ultimately summed in block 342 and a final summation result S 344 is generated internally within the neuron computational stream. A threshold detector and decision block 350 then compares the value S 344 to the stored influence field value 346 and makes a determination as to whether the influence field threshold conditions have been met. If the threshold conditions have been met, then an output value R 352 is generated that indicates that the VOI has been recognized. This is generally performed by outputting a value for R 352 that matches the category-ID 348 stored within the neuron. If the threshold conditions have not been met, then the output value R 352 is set to some predefined value indicating that the VOI is unrecognized.

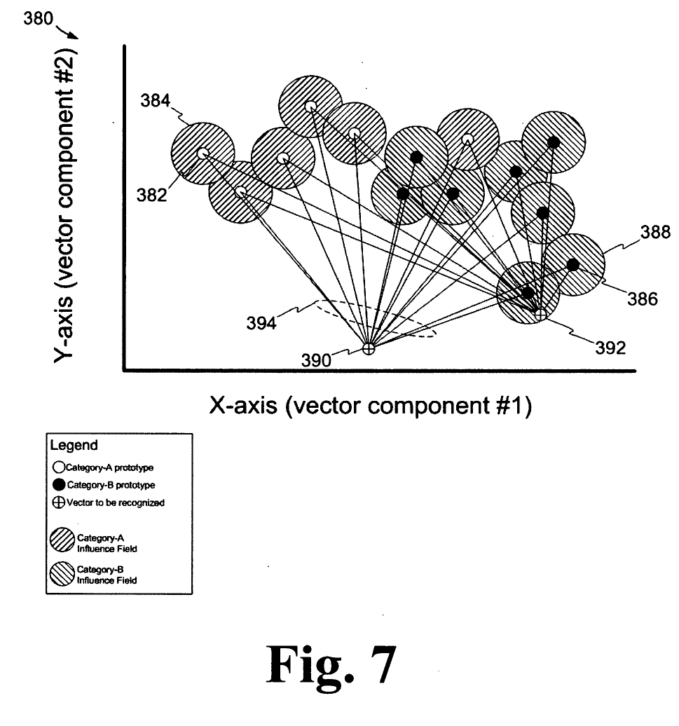

FIG. 7 is a feature space map 380 similar to that shown in FIG. 3 that has been enhanced to illustrate the number of prototype comparison operations that must generally be performed to determine if a VOI should be declared as recognized. Category-A prototype points and their associated influence fields are shown representatively as 382 and 384. Category-B prototype points and their associated influence fields are shown representatively as 386 and 388. Two VOI feature space points are shown as 390 and 392. A series of lines shown collectively as 394 illustrate the general extent to which prototype comparisons must be performed to determine if a pattern recognition condition should be reported. It can be reasonably deduced that arbitrary hyper dimensional binary vector data makes it difficult to presuppose where in the feature space map and appropriate recognition might be accomplished.

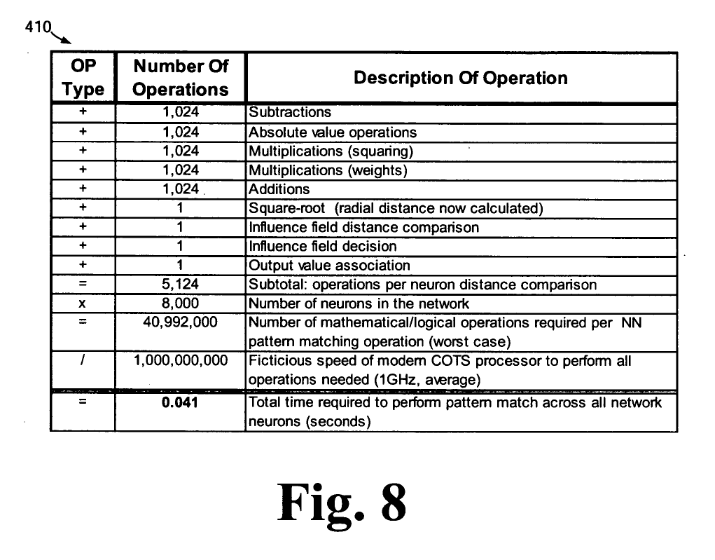

FIG. 8 is a computational worksheet 410 that illustrates the computational burden that is typically incurred when pattern recognition search operations similar to those shown in FIG. 7 are performed. The worksheet illustrates how a field of prototypes might be searched as shown in the feature space map such as 380. The individual computational steps accounted for are those that would likely be involved when processing neural network structures like 322 according to the equation 278. As can be observed in the worksheet the computational burden grows very rapidly as the dimensionality of the network increases or the number of neurons increases.

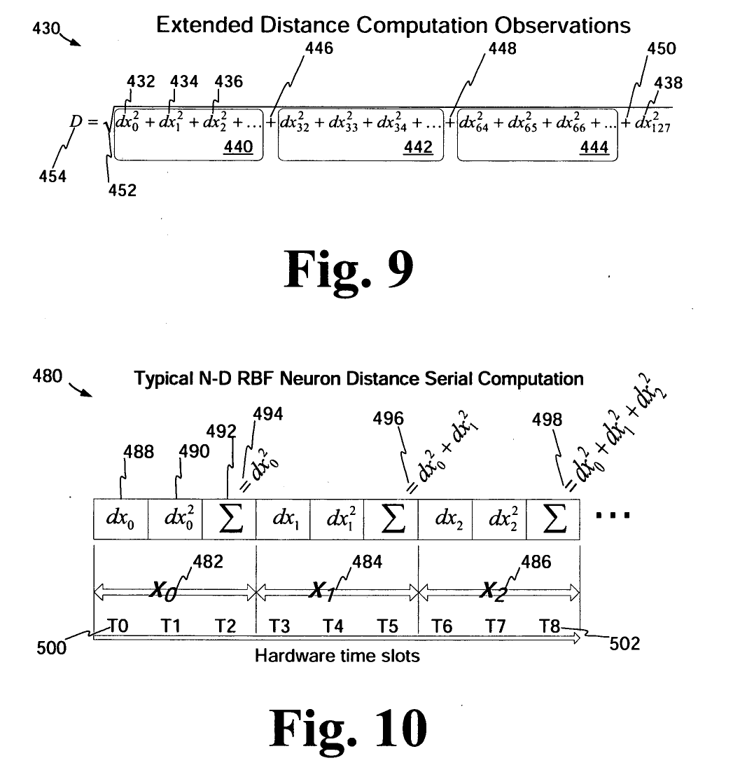

FIG. 9 is a block diagram of an equation 430 that shows how a distance calculation of high dimensionality can be performed. The span of the vector element derivative components included in this equation range from dX0 432 through dX127 438. A particular consequence in this diagram is the fact that it illustrates how mathematical properties can be used to group certain computational elements together to achieve the same result. The grouping shown highlights the fact that groups of computational elements such as 440 through 444 can be computed on independently. Similarly, the computational groups 440 through 444 themselves contain further computational terms. When these group computations are computed separately and then added together as shown in 446, 448, and 450 the net result is the same as if no computational grouping were performed. This mathematical artifact will be exploited in subsequent figures as a method of performance optimization. After a final summation is performed a square-root computation 452 is performed and a final distance result ‘D’ 454 is generated.

The figure also stimulates some observations regarding the general type of equation shown as 430. These observations are: (a) various operations such as dXn generation, multiplication, and running summations can all be performed independently from one another, (b) clusters of such computations can be performed in parallel, (c) cluster computations could be performed by separate computational units and maintained on separate memory systems when extremely large feature vectors or extremely large neural networks must be implemented, and (d) square root computations can be deferred or possibly eliminated in many instances.

FIG. 10 is a block diagram 480 that shows how a series of computational steps like those shown in 270 might be performed. The diagram shows a series of computational hardware time slots shown representatively as 500 through 502. Each time slot is allocated to performing a single computation operation. Operation 488 represents the computation of the X0-axis offset dX0. Operation 490 represents the computation of the square of dX0. Operation 492 represents the generation of a cumulative sum. Operation 494 represents the cumulative summation result generated thus far in the computational process. The extent of the processing steps related to feature vector element X0 is shown as 482. Operation 496 shows the result of the cumulative summation generated thus far in the processing sequence. The extent of processing steps for feature vector elements X1 is shown as 484. The extent of processing steps for feature vector elements X2 is shown as 486. Operation 498 shows the result of the cumulative summation generated thus far in the processing sequence. Such a processing sequence can be extended as needed to accommodate arbitrary length feature vectors using the methods shown thus far. Such a sequential processing methodology could be implemented in hardware to process feature vector data directly from memory devices at high-speed. Processing speeds would be limited only by the rate at which feature vector data could be read from such memory devices.

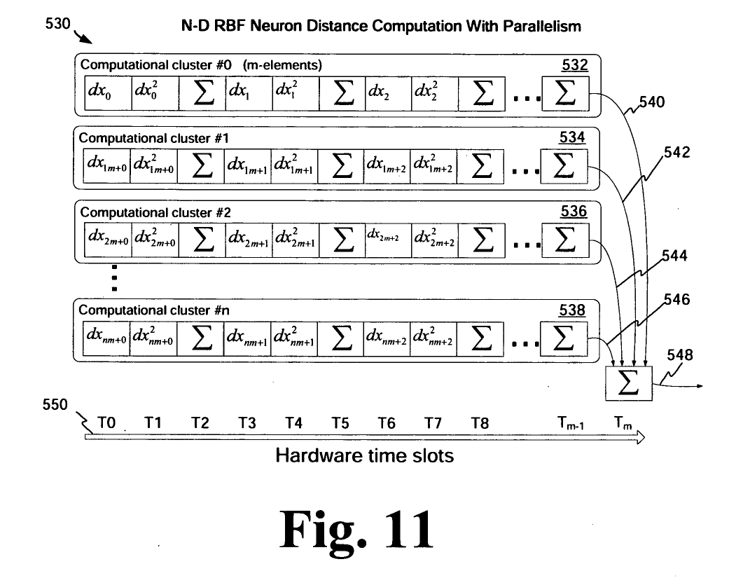

FIG. 11 is a block diagram 530 that illustrates one method of removing the speed limitations of the sequential processing method shown in 480 by applying multiple computational units. Again, hardware time slots are shown representatively along the timeline 550. Blocks 532, 534, 536, and 538 show computational clusters associated with various sequential processing steps. Block 532 is associated with the processing of feature vector element X₀ through Xₘ₋₁. Block 534 is associated with the processing of feature vector elements X₁ₘ through X₁ₘ₊ₘ₋₁. Block 536 is associated with the processing of feature vector elements X₂ₘ through X₂ₘ₊ₘ₋₁. Block 538 is associated with the processing of feature vector elements Xₙₘ through Xₙₘ₊ₘ₋₁. To complete the cumulative sum required by an example RBF distance computation the intermediate values 540, 542, 544, and 546 are summed and a final cumulative sum is generated 548. Although the final cumulative sum 548 does not represent a radial distance value similar to 454 as shown in FIG. 9, it does represent the bulk of the computational work as identified earlier in the example of FIG. 8. The computational time savings available using the method shown is significant. If the number of individual feature vector elements to be processed is ‘T’ and the number of computational clusters employed in the generation of a cumulative sum 548 is ‘n’, then be computational speed improvement attributable to the method shown is approximately ‘T/n’.

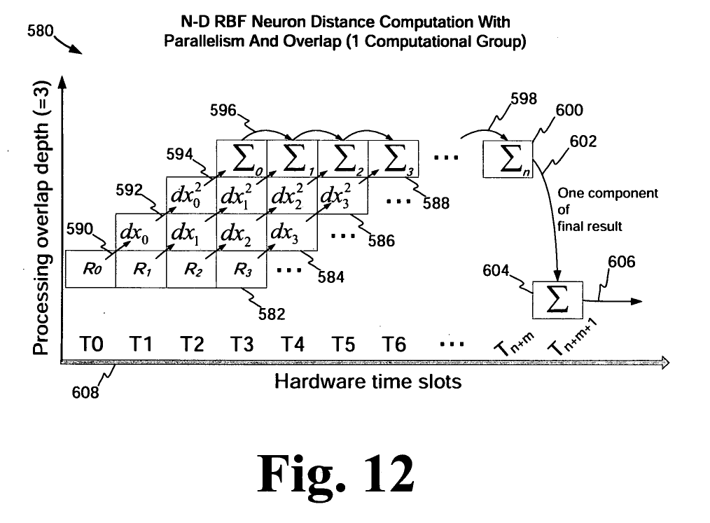

FIG. 12 is a block diagram 580 that illustrates a method of further reducing computational time for RBF distance (and other) computations by overlapping operations of various types within each computational timeslot. Computational time slots are shown on the timeline 608. Blocks representatively shown as Rn 582 reflect the acquisition of feature vector component values (likely from memory devices). Blocks representatively shown as 584 reflect the computation of vector-axis offset values dXn. Blocks representatively shown as 586 reflect the computation of dXn-squared values. Blocks representatively shown as 588 reflect the computation of running summation values. The arrows shown as 590, 592, and 594 reflect related computational steps performed during subsequent time slots. The arrows 596 through 598 representatively show the cumulative sum generation process. The final cumulative sum for an input value Rn would be generated during the operation shown as 600. The output generated 602 could then be presented to a next-level cumulative sum generation process (or other operation) 604 and a next-level result generated 606. Such a series of steps could be a part of a larger computational acceleration strategy as will be subsequently shown.

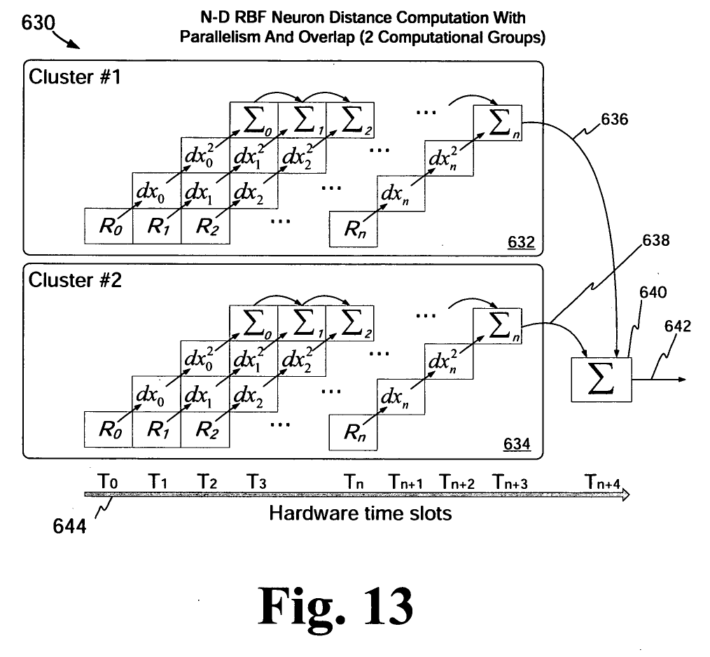

FIG. 13 is a block diagram 630 that illustrates a method of further reducing computational time for RBF distance computations (or other computations similar in structure) by overlapping multiple clusters of computations as shown above in 580. A timeline identifying various computational time slots is shown as 644. Each computational cluster shown (632 and 634) is intended to reflect the strategy shown earlier as 580. 636 and 638 represent the cumulative sums that might be generated by each computational cluster. A final cumulative sum 642 is shown being generated by block 640. The result 642 in this example is not necessarily a final RBF distance value as shown earlier as 272; however, it does typically represent a substantial portion of the computational work. The method shown further reduces the time required to perform computationally intensive operations; the RBF distance calculation shown is just one example of how such a technique can be applied. Other algorithms that can be decomposed into similar mathematical operations are likely candidates for the performance-improving methods shown.

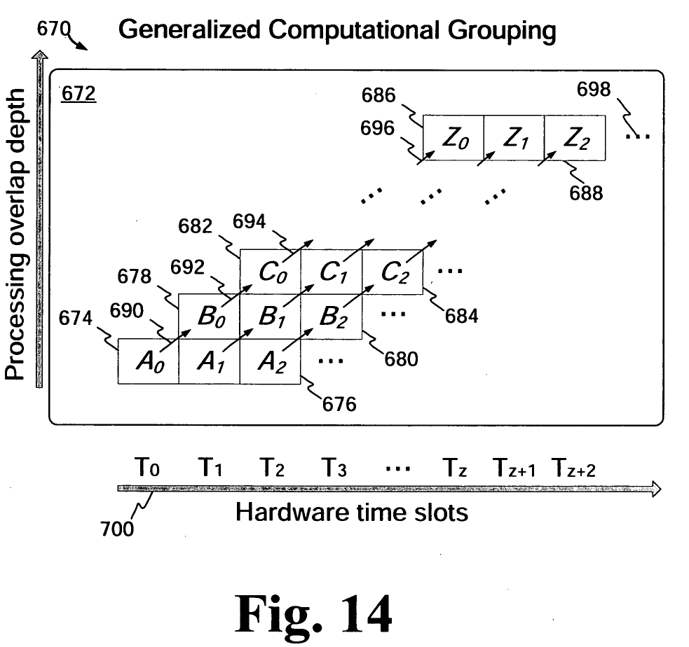

FIG. 14 is a block diagram 670 that illustrates how an extensive series of computational operations can be organized in a way that allows significant performance improvements to be achieved. The method shown 672 is similar to that of 580. A timeline identifying various computational time slots is shown as 700. The figure shows a series of computational processing steps of various types An (674 through 676), Bn (678 through 680), Cn (682 through 684), through Zn (686 through 688). A series of arrows (690, 692, 694, 696) indicates the progression of the various computational steps as measured in time. The computational sequence A0 through Z0 begins at timeslot T0; the computational sequence A1 through Z1 begins at timeslot T1; the computational sequence A2 through Z2 begins at timeslot T2; by analogy, the computational sequence An through Zn can be extended 698 such that it begins at timeslot Tn. Although not applicable to every type of computing problem, when a series of computations must be performed that lend themselves to mathematical decomposition as described earlier significant speed improvements can be attained.

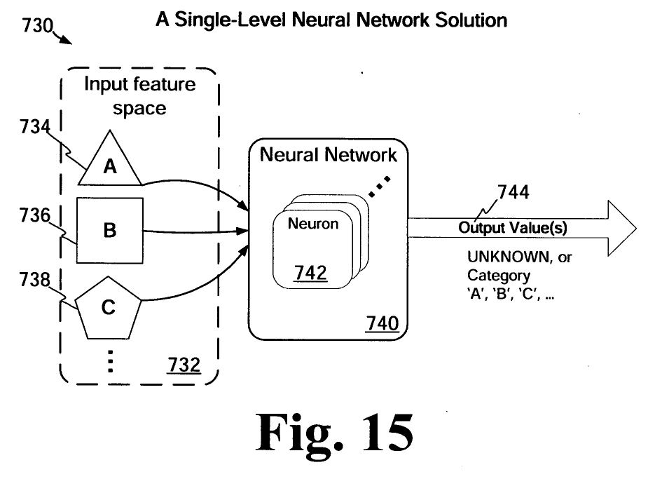

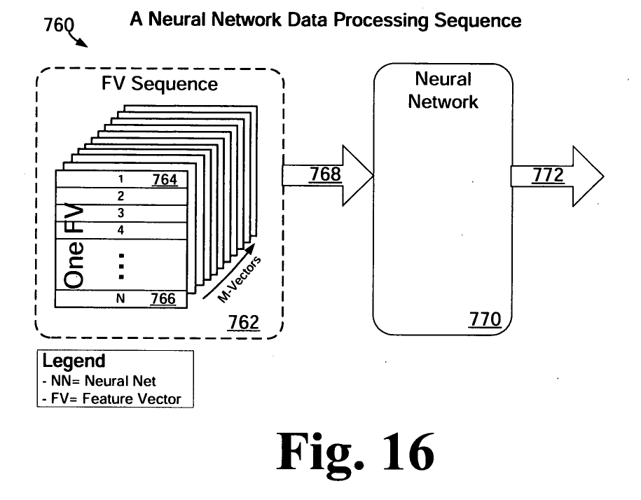

FIG. 15 is a block diagram 730 of a single level neural network based pattern recognition system. Feature space 732 represents the various elements of the problem space to be identified. The blocks 734, 736, and 738 are intended to represent differing VOIs to be identified by a neural network pattern recognition system 740. The neural network pattern recognition system 740 is shown as being composed of an array of individual neurons shown representatively as 742. As the neural network delivers pattern recognition results an output value 744 is generated. Possible output values might include a series of category-ID numeric values as well as a value reserved to indicate that the input feature vector was unrecognized.

FIG. 16 is a block diagram 760 of a long-running feature vector sequence being presented to a neural network based pattern recognition system. A long-running sequence of feature vectors representing the characteristics of objects to be recognized is shown as 762. Individual feature vectors might range from one to ‘n’ elements in size; the first feature vector element is shown as 764 and the last vector element is shown as 766. The series of feature vectors is provided as input 768 to the neural network pattern recognition system 770. The neural network performs pattern recognition operations on this long-running feature vector data stream and ultimately provides a long-running series of output values 772. One characteristic of this diagram is that it illustrates the difficulty of identifying pattern recognition problems when processing long-running feature vector data streams. One can imply that there is a need for additional neural network capabilities to assist in diagnosing such pattern recognition problems.

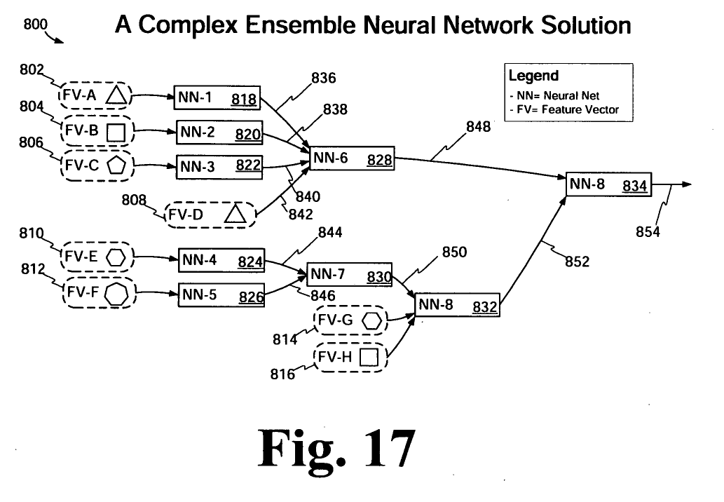

FIG. 17 is a block diagram 800 of a complex ensemble neural network solution. Block 802, 804, 806, 808, 810, 812, 814, and 816 represent various feature vector input streams. Block 818, 820, 822, 824, 826, 828, 830, 832, and 834 represent various constituent neural network based pattern recognition engines. The arrows 836, 838, 840, 842, 844, 846, 848, 850, 852, and 854 show output values from the various neural network subsystems. One characteristic of this diagram is that it illustrates the difficulty of identifying pattern recognition problems buried deep within a complex ensemble neural network system. One can imply that there is a need for additional neural network capabilities to assist in diagnosing such pattern recognition problems.

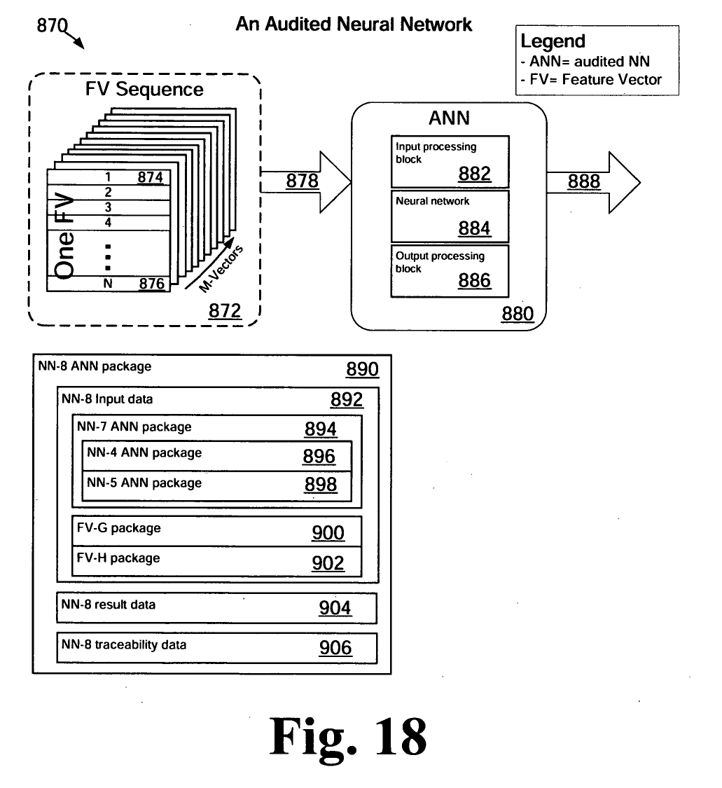

FIG. 18 is a block diagram 870 of an Audited Neural Network (ANN) 880 processing scenario. Block 872 represents a long-running sequence of feature vectors whose individual feature vector elements range from one 874 to ‘N’ 876. A long-running sequence of feature vectors is provided to the audited neural network pattern recognition system via the pathway 878. An audited neural network 880 consists of an array of neurons 884 as shown previously (similar to 740) along with some additional audit-data processing blocks 882 and 886. An Input Processing Block (IPB) 882 is shown whose purpose is to process the audited input data stream to extract input values for the internal neural network 884. An output-processing block (OPB) 886 is shown whose purpose is to encapsulate input values, output values, and network debugging information and then present this data as output 888 for downstream analysis. Typically, this analysis would be performed by a downstream ANN or some other processor. Alternatively, the ANN output data package presented as 888 might be a final result from a complex ensemble neural network computing solution such as 854.

An example schematic of a hierarchical ANN data package that might be generated from an ANN 880 is shown as 890. The example used in the creation of this data package represents a structure that might be output from a hierarchical ensemble neural network solution such as that shown as NN-8 832 in FIG. 17. This example shows an ANN data package 890 that contains elements that describe its input values 892, its internal neural network output value 904, and auditing data 906. The input value consists of a hierarchical structure that encapsulates a list of information suitable to form a feature vector for the local ANN neural network 884. The IPB 882 is responsible for extracting information from block 892, generating a feature vector suitable for network 884, and making this block of data available for inclusion in the NN-8 output data package 890. After a pattern recognition operation is performed by the internal neural network 884 the OPB 886 is responsible for assembling an output data package that consists of the input data 892, the ANN result 904, and a block of audit data 906. Such a package of traceability data 906 might include an ANN ID code that has been uniquely assigned to the current ANN, a timestamp, an IPB input sequence number, and other data. For completeness in this example, the input data package 892 would likely include a NN-7 ANN data package 894 along with a package describing the current values (900, 902) for FV-G 814 and FV-H 816. The internally encapsulated NN-7 ANN data package 894 would include the NN-4 ANN package 896 as well as the NN-5 ANN package 898. Although such traceability data significantly adds to the level of data traffic communicated between ANN subsystems, the effect would likely be minimal compared to typical internal NN 884 processing speeds. The advantage of such traceability data would be that more reliable complex ensemble neural network solutions may be created more quickly.

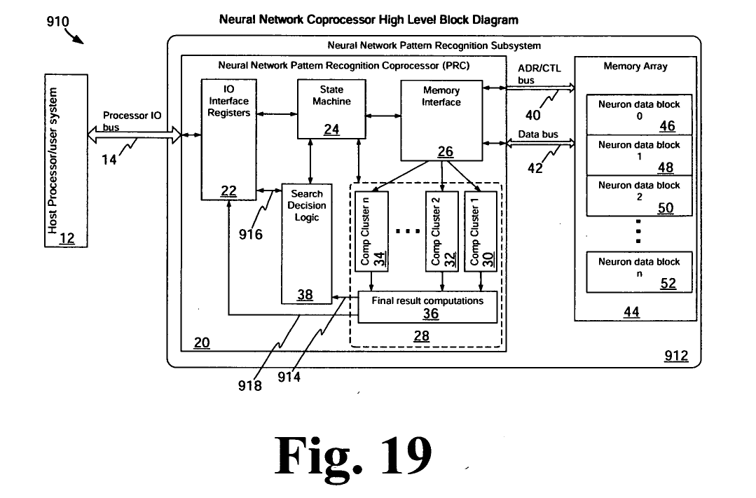

FIG. 19 is a high-level block diagram 910 of a neural network enabled pattern recognition system 912 that acts as a coprocessor to some microprocessor or other user computing system 12. The pattern recognition coprocessor (PRC) 20 communicates with the user computing system 12 via some form of processor I/O bus 14. The PRC 20 is supported by a memory array 44 and communicates with this memory via address, control, and data buses shown collectively as 40 and 42.

In this example the PRC 20 interfaces with the processor 12 via a series of I/O interface registers 22. Through these I/O registers 22 the processor 12 can communicate with the PRC 20, issue commands, and gather status. The main purpose of the PRC is to process pattern recognition data within the memory array 44 as instructed by the host processor 12. Blocks 46, 48, 50, and 52 represent a (potentially long) list (or other structural organization) of neuron data blocks that might contain data pattern recognition data similar to that shown within 320. Such data might include prototype vector elements similar to those shown representatively as 324 through 326, weight value vector elements similar to those shown representatively as 332 through 334, a neuron influence field size (or threshold value) as shown in 346, and a neuron category-ID as shown in 348. Such data might also include traceability data showed in FIG. 18 as 890 as well as possibly other application-specific neuron related data.

Internally, the PRC 20 includes an I/O interface register set 22, a controlling state machine 24, a memory interface controller 26, a high-level computational block 28, and a search decision logic block 38. The high-level computational block 28 consists of a series of internal computational cluster blocks (shown representatively as 30, 32, and 34) and a final result computational block 36. Internally within the PRC 20 the data path 914 can provide the final computational result from 36 to the search decision logic 38. The search decision logic can then update interface registers via the communication path 916. Alternately, the computational block 36 might be configured to provide a computed value directly to the interface register block 22 via the data path 918 in a hierarchical computational environment.

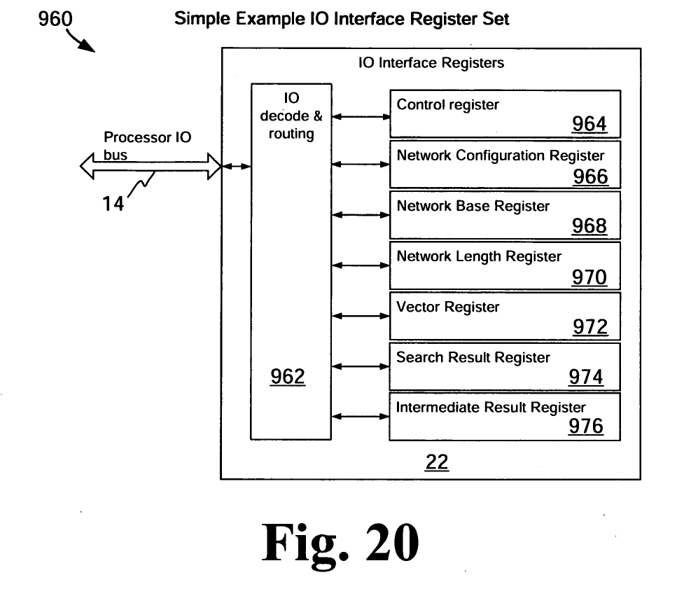

FIG. 20 is block diagram 960 that shows an expanded view of a simple example I/O interface register set 22 that might be a part of a PRC 20. The register set 22 interfaces with an external processor via the data bus shown as 14. The interface register set contains I/O decoding and routing logic 962 allows the external processor to access data within the various registers as needed. The registers shown are a Control Register 964, a Network Configuration Register 966, and Network-Base Register 968, a network length register 970, a vector register 972, a search result register 974, and an intermediate result register 976.

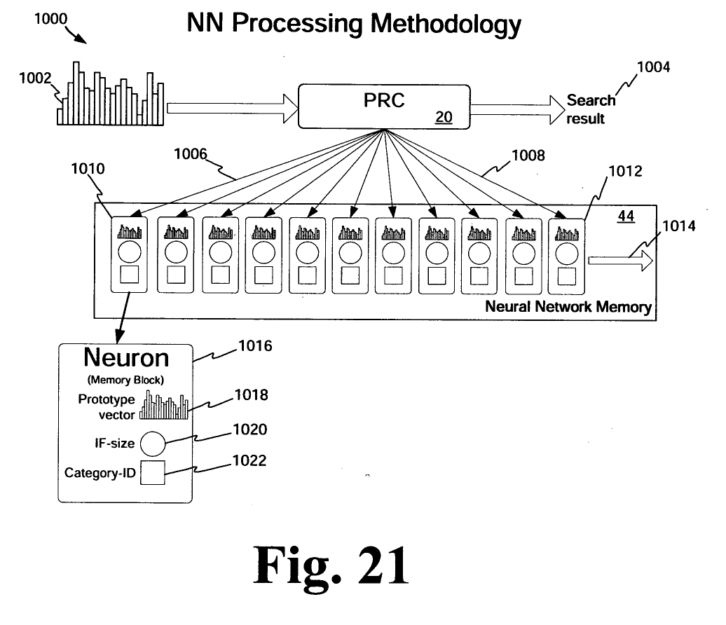

FIG. 21 is a block diagram 1000 that represents a typical processing sequence that might be performed by a typical PRC shown earlier as 20. 1002 represents an input feature vector (VOI) as might be supplied by an external processor such as 12. A high-level view of a PRC is shown in this example as 20. The search result generated by PRC 20 is shown as 1004. Memory array 44 is a neural network memory array that is optionally expandable as indicated by 1014. The memory array 44 contains a series of neuron data blocks shown representatively as 1010 through 1012. These neuron data blocks are equivalent to those shown earlier as 46 through 52. The method by which the PRC 20 accesses the various neuron data blocks (1010-1012) that are part of a neural network search list is shown representatively as 1006 and 1008′. An expanded view of a neuron data block such as 1010 is shown as 1016. The neuron data block 1016 is shown in this simple example to contain only a prototype vector 1018, an influence field size 1020, and a category-ID 1022.

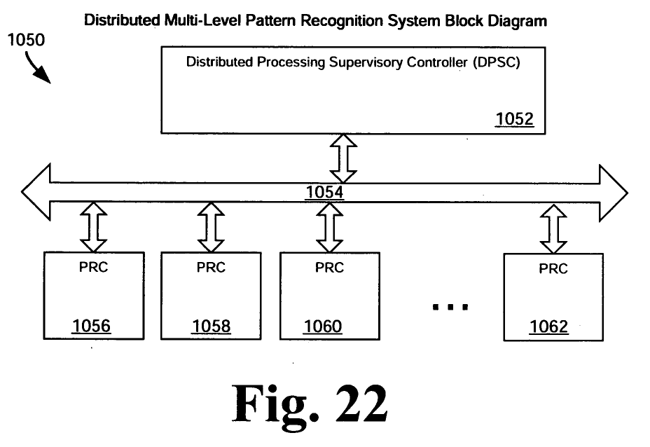

FIG. 22 is a block diagram 1050 that shows how a cluster of computational modules could be used to form a more capable neural network pattern recognition system or other generalized computational subsystem. A Distributed Processing Supervisory Controller (DPSC) is shown as 1052. A series of subordinate neural network pattern recognition subsystems is shown as 1056, 1058, 1060, and 1062. Each of the subsystems 1056 through 1062 is envisioned to be similar to that shown as 912. A bus, network, or other communication mechanism used to connect the DPSC 1052 to the various subsystems (1056-1062) is shown as 1054.

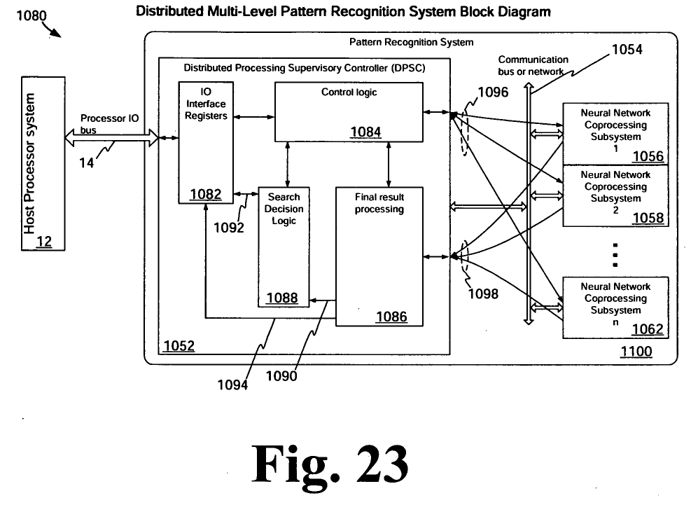

FIG. 23 is a block diagram 1080 that shows how a multi-level pattern recognition system 1100 might interact with a host microprocessor system 12 and a series of subordinate neural network subsystems shown as 1056, 1058, and 1062 to provide accelerated pattern recognition services. The DPSC 1052 is shown communicating with a controlling processor 12 via the processor I/O bus 14. An I/O interface register block is shown as 1082. A DPSC control logic block is shown as 1084. A final result processing block is shown as 1086. A search decision logic block is shown as 1088. Paths of communication are shown as 1090, 1092, and 1094. A communication bus, network, or other appropriate connectivity scheme used by the DPSC to communicate with a series of subordinate neural network coprocessing subsystems is shown as 1054. Paths of DPSC communication and control are shown representatively as 1096. Various data paths are used to communicate results back to the DPSC 1052 are shown representatively as 1098.

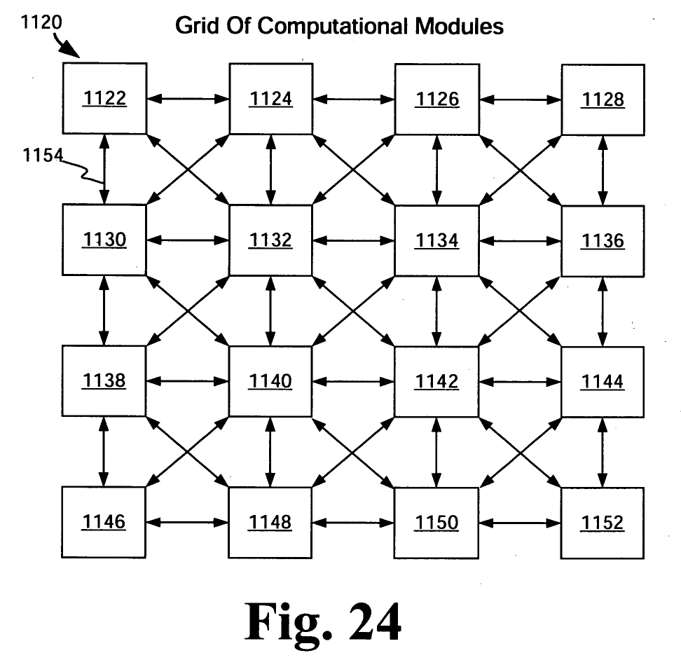

FIG. 24 is a block diagram 1120 that shows a view of how the various elements of a larger distributed processing pattern recognition system 1100 might be interconnected. In this example component configuration a series of computational modules similar to the pattern recognition subsystems (PRC) shown earlier as 912 would be connected either physically or logically in a grid or mesh 1120. The various PRS units 912 are shown representatively as 1122 through 1152. The paths of communication are shown representatively as 1154.

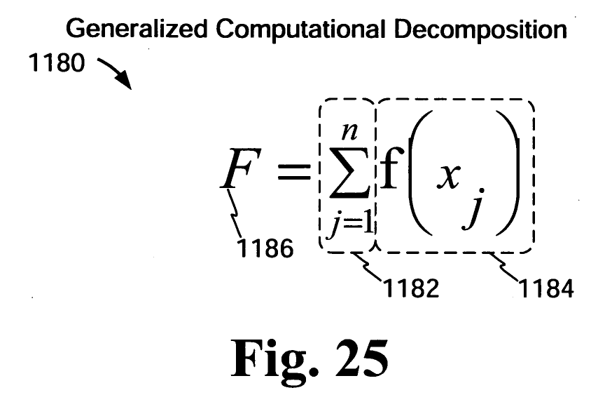

FIG. 25 is a diagram 1180 that illustrates the form of computations that are likely to benefit from the computational methods described thus far. The computational result is shown as 1186. A series of composite computational operations is shown as 1182. Individual computational operations are shown as 1184. We note that computational operations 1184 that are largely independent from one another and are subject to the mathematical property of associatively are most likely to receive the maximum benefit from the methods described thus far.

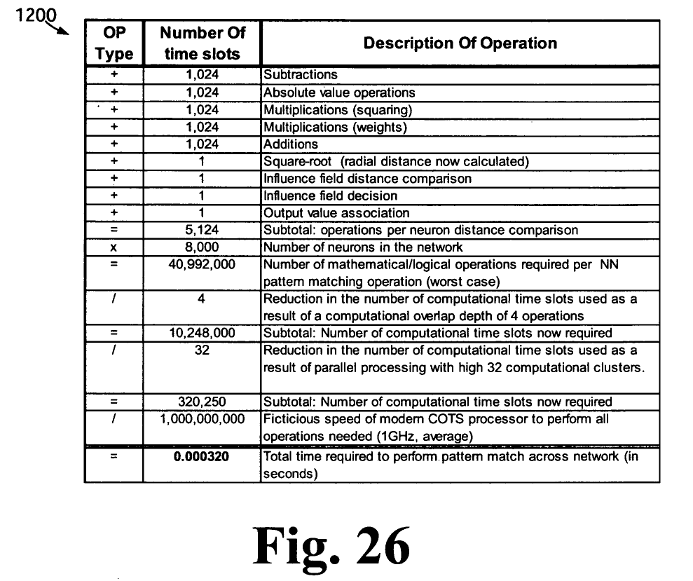

FIG. 26 is a computational worksheet 1200 similar to that shown earlier as 410 that illustrates the computational time reduction that can be realized when computational methods are employed similar to those described in the processing strategy 630. The computational example used reflects a weighted RBF neuron distance calculation as shown in 278.

Referring to FIG. 1, in operation pattern recognition system 10 operates under the coordinated control of a host processor system 12. The processor 12 is connected to a page scanner 16, a pattern recognition system 20, and a display device 18 via a processor I/O bus 14. Processor 12 acquires a scanned image using the page scanner 16 and the image data captured would then be stored within the processor's own memory system. To identify characters within the scanned image the processor would then extract a series of smaller image elements such as 74 from across the length and breadth of the scanned image in memory (similar to 74 within the area of 72). These smaller image segments would then be converted one-by-one to feature-vector elements (84-86) by scanning rows of data (80-82) within each smaller image segment; ultimately, feature vectors such as 88 would be formed.

At a high level, each sub-image 74 extracted by the processor 12 would have the corresponding feature vector submitted to the Pattern Recognition Coprocessor (PRC) 20 for pattern recognition purposes. The PRC 20 then scans an attached (or otherwise accessible) pattern recognition database stored within a memory array 44 (or other useful data storage system). If the PRC is able to identify a match condition it responds with an ID code (otherwise known as a category-ID) to the processor 12. In a simplistic implementation the category-ID might simply be the ASCII character code for the character detected. If the PRC is unable to identify a match condition from the feature vector it might respond with a unique status code to indicate to the processor 12 that no match has been found. In a very simplistic implementation the processor 12 might simply print out a list of scanned-page pixel coordinates and the associated character values where characters data patterns have been successfully recognized.

Referring to FIG. 6, the theoretical operation of a simple RBF neuron as a computational element in isolation is shown as 322. In this example the neuron encapsulates a variety of data values including a prototype feature space coordinate Pn (328-330), an optional weight-vector Wn (332-334), an influence field size value 346, and a category-ID 348. During operation the neuron 322 acquires a VOI vector (324-326), computes dXn values 336, squares the result using 338, includes the weight vectors using 340 if appropriate, and sums the various computed results using 342. We note that ultimately the neuron shown as 322 implements the hyperdimensional distance equation shown in 278. It should also be noted that other methods are available to determine whether a VOI lies within a neuron's influence field. Other computational techniques utilizing hypercubic-methods, hyperpolyhedron-methods, and other hyperdimensional geometric shapes are certainly candidates for use. A detailed discussion of such influence-field computational methods is not included in this document for brevity. However, the computational methods described in this document specifically contemplate the use of such methods in certain applications.

A graphical representation of this a simple 2D RBF distance computation is shown as 200 (where all weights equal 1). Applying these principles back to the PRC in FIG. 1 we see that the various neuron data values in this implementation (328-330, 332-334, 346, and 348) would be stored within the memory array 44 as neuron data blocks 46 through 52. All of the mathematical computations performed by 322 would be performed in example 10 by the computational block 28. The decision function 350 would be provided by the search decision logic block 38. The neuron decision result value R 352 would be generated by block 38 and delivered as one or more status values to the I/O interface register block 22 where it would be accessible to the processor 12.

The previous paragraph summarized the operational processing for a single neuron such as 46. However, when the processor 12 presents a feature vector such as 88 to the PRC 20 many neuron data patterns (46-52) would likely need to be searched. The responsibility for searching a list of neuron data blocks such as data blocks 46-52 lies primarily within PRC control state machine 24. The control state machine 24 coordinates repetitive accesses to the memory array 44 to acquire values from the neuron data blocks, it coordinates the computation of results within 28, it coordinates the decisions made by 38, decide whether to continue searching, and coordinates the delivery of final search results to the I/O registers 22. Ultimately, the processor 12 is provided with a result that indicates whether a match was found or not; if a match was found the PRC 20 would provide the category-ID of the matched character.

This example assumes that the pattern recognition database stored within the memory array 44 has been previously initialized prior to the operation of the PRC 20. Such might be the case if the pattern recognition database was implemented with previously initialized FLASH or ROM based memory devices.

Referring to FIG. 7, the operation of a pattern recognition system such as 20 might require a search of a pattern recognition database for acceptable matching conditions as shown by 394. If the number of prototypes (or neurons) is large the amount of computational effort required to determine if a match-condition exists could be quite large.

Referring to FIG. 8, the operation of a pattern recognition system such as 20 is shown to be very computationally intensive as the dimensionality of feature vectors increases or the number of neuron data patterns increases. The computation shown 410 refers to feature vectors with a dimensionality of 1024. Such feature vectors might be appropriate if high-resolution grayscale image were acquired and 1024-element feature vectors similar to 88 were formed from 32×32 pixel image subregions similar to 74. This example shows one potential practical application for rather large feature vectors within an image pattern recognition environment. Of course, similar logic could be employed to highlight the potential practical application of much larger feature vectors and the potential need for pattern recognition systems capable of processing such large feature vectors.

Referring to FIG. 11, the operation of a pattern recognition system employing the strategy 530 is shown. The method 530 can provide a computational speed improvement proportional to the number of computational clusters employed. As an example, within the computational subsystem 28 a number of computational clusters are shown as 30 through 34. If 16 such computational clusters were employed a computational speed improvement by a factor of approximately 16 would likely result.

Referring to FIG. 12, the operation of a pattern recognition system employing the strategy shown as 580 can provide a computational speed improvement proportional to the number of computational operations performed in parallel during any timeslot. This form of parallelism can provide a computational speed improvement by a factor approximately equal to the number of computational operations performed in parallel at any point in time. As an example, as shown in 580 if four computations are performed in parallel during every timeslot, then a computational improvement by approximately a factor of four would result.

Referring to FIG. 13, the operation of a pattern recognition system employing the strategy shown as 630 can provide a computational speed improvement proportional to the number of computational operations performed in parallel during any timeslot. As an example, if each computational cluster (632 and 634) performs four computational operations during any single timeslot and two computational clusters are employed, and we can see that a total of eight computational operations are active during most timeslots; therefore, approximately an 8-fold computational performance improvement can be expected from such a computational configuration.

Referring to FIG. 14, the operation of a pattern recognition system employing the strategy shown as 670 can provide a computational speed improvement proportional to the number of computational operations being performed in parallel during any timeslot. Given the computational configuration shown, such a performance improvement achieved through parallelism could be quite substantial. The figure also contemplates the fact that the nature of each computation such as An 674, Bn 678, Cn 682, might not be fixed in a flexible hardware configuration. Instead, a generalized computational strategy might be employed whereby a flexible hardware computational engine might be configured at runtime to provide a wide variety of computational operations. Such operations might be quite flexible and mimic the flexibility and range of computational operations of a modern commercial microprocessor. The figure also contemplates the use of a Reverse Polish Notation (RPN) type operations to support a flexible computing strategy in such an environment.

Referring to FIG. 17, the operation of a pattern recognition or generalized computational system employing a complex ensemble neural network configuration strategy is shown 800. This example shows how a variety of feature vector data streams of various types (802-816) might be provided to a complex ensemble collection of neural network engines (818-834). The outputs of various neural networks are shown being fed as inputs to subsequent neural networks. An example of this is the outputs of the networks 824 and 826 been provided as the feature vector inputs to neural network 830. The value of such a network configuration is that each of the individual neural networks can be trained in isolation, validated, and then integrated within the larger ensemble neural network configuration. This has advantages both in reducing the complexity of training and also and improved understandability and debug-ability.

Referring to FIG. 18, the operation of an audited neural network 870 is shown. The audited neural network behaves largely the same as its non-audited cousin except for the fact that some additional input data is generally expected; also, some additional output data is typically generated. As a simpler example, NN-7 830 is provided with the outputs from two predecessor networks (824 and 826). The NN-8 input data package it receives 894 consists of 896 and 898. When NN-7 generate its output audited data package for output it includes 896, 898, and data similar to 904 and 906 (not shown separately in 890 for clarity; assumed to be a part of 894). In this way, when the NN-7 audited data package 894 is received by NN-8 a rather complete history of the data that stimulated the particular result generated is available. This is important when a complex network must be debugged.

As shown in the NN-8 audited data block 890, when NN-8 generates its pattern recognition result it packages up all of its input data items 892 along with its internal neural network 884 output value (888/904) and some other traceability data 906 as described earlier. The entire package of information 890 is presented to downstream networks or external systems. When such a package of data arrives it provides a rather complete picture of what input values were incorporated into the final result. Additionally, if certain values were unexpected the available data can provide great help for engineers or scientists responsible for maintaining such systems.

Referring to FIG. 19, a somewhat more expanded view of a typical PRC is shown 910. Although much of the functionality of the PRC has been previously described in the earlier operational description 10, some details of the implementation deserve further explanation. The PRC embodiment 20 shown reflects a computational subsystem 28 that consists of a number of computational clusters (30-34) and a final result computational block 36. Each computational cluster (30-34) is envisioned to utilize the accelerated computational approaches identified in 630 and 670 to the maximum extent practical for the implementation. Using these methods significant performance improvements can be attained as compared to a simple sequential series of operations similar to 480 as might be performed by a pattern recognition software implementation running on a modern COTS processor system. Using an approach such as 630 significant performance improvements can be attained.

Roughly, performance will scale based on the number of computational clusters (30-34) employed and the computational parallelism depth employed by each cluster. Of course, to support large numbers of computational clusters may require an unusually wide memory system 44 to feed such clusters with data in a timely fashion. Therefore, to achieve high performance the current figure contemplates the use of very wide memory subsystems 44 when high performance is desired. However, it is also contemplated that useful PRC 20 implementations can be generated without the use of very wide memory subsystems 44.

One other important feature of the PRC shown in 910 are the data paths 914, 916, and 918 along with the neural network pattern recognition subsystem boundary shown as 912. As the computational block generates final mathematical results in 36 the controlling state machine 24 consults I/O register configuration data 22 and determines whether the current PRC 20 is operating in a standalone fashion or is supporting a larger multilevel computational cluster (see 1050). If the PRC 20 is operating in a standalone fashion it would typically deliver computed results (RBF distance calculations or other types of calculations) to the search decision logic block 38. In this standalone scenario the state machine 24 and the decision block 38 would work closely to determine when a match condition is found and the current pattern recognition operation should terminate. Once terminated, results would be delivered to the I/O register block via pathway 916 and the processor 12 would be notified via a status change in the I/O interface registers 22. Alternately, if the PRC 20 is configured to operate as a computational subsystem in support of a larger computational group (i.e.; not standalone), then the state machine 24 might configure the computational block 36 to deliver its computational results to I/O interface registers 22 via the pathway 918. This would allow certain computational decisions to be deferred to a higher-level decision block within another subsystem (discussed shortly).

Referring to FIG. 20, a detailed view 960 of a typical PRC register set 22 is shown. Here again the PRC 20 external processor I/O bus interface is shown as 14. An IO address decode and data routing block 962 is shown to provide the external processor with direct access to the various registers within the I/O interface register block 22. In this simplified PRC register set example a small series of registers are shown.

In the simple environment of the example configuration shown, if an external processor 12 desires to configure the PRC 20 to perform a pattern recognition operation it might: (a) load the Network Base Register 968 with a starting offset within the memory array 44 where a particular set of neuron data blocks (46-52) is known to reside; (b) load the Network Length Register 970 with a value that tells the state machine 24 the maximum number of neuron data blocks (46-52) to be searched; (c) load the Vector Register 972 would be feature vector to be recognized; (d) load the Network Configuration Register 966 with a value that tells the state machine 24 about the configuration of the neuron data blocks (46-52) so that it knows how to configure the PRC computational hardware 28; (e) load the Control Register 964 with a value that indicates that the PRC should start pattern recognition processing in a standalone fashion. Once started, standalone PRC processing operations might repeatedly compare the feature vector value stored in the vector register 972 with the various prototype values stored within the memory array (46-52). If a match is found the state machine 24 and the decision block 38 would arrange for the Search Result Register 974 to be loaded with information regarding the pattern match found. Additionally, state machine 24 would update the contents of the control register 964 to indicate that the pattern recognition operation has completed.

If the PRC 20 is configured to perform a pattern recognition operation in a non-standalone fashion one of the significant differences would be that the intermediate result register 976 would generally be updated upon completion of a search operation. The value loaded into register 976 would be available to a higher-level coordination processor as will be described shortly.

Referring to FIG. 21, a high-level view 1000 of a typical PRC 20 pattern recognition sequence is shown. Here, the initiation of a pattern recognition operation is shown graphically as with the presentation of a feature vector 1002 to a PRC 20. The PRC then searches a pattern recognition database stored in an expandable memory array (44, 1014). The simple sequence of memory accesses is shown in this example representatively as 1006 through 1008. This high-level view only reflects a simple neuron structure in shown in 1016. Additional audit-data complexity as shown in 870 is not shown. Overall, the PRC 20 must decide as a result of its search operation whether a pattern match should be reported or not. If so, then the search result 1004 would be presented back to the requesting processor (typically 12) that would indicate an appropriate category-ID.

Referring to FIG. 22, a high-level view 1050 of a typical multi-level pattern recognition system is shown. A prominent feature of this system configuration is the use of a Distributed Processing Supervisory Controller (DPSC) 1052 to coordinate the application of a number of PRC 20 based computational subsystems to achieve accelerated computational results (search results). To achieve computational acceleration the DPSC 1052 utilizes a number of PRC 20 based Pattern Recognition Subsystems (PRS) similar to 912. Each PRS consists of a PRC 20 along with an associated memory array 44. The use of a number of PRS blocks 912 significantly adds to the computational power available in the overall pattern recognition system 1050; such a configuration also allows scalability in terms of neural network size because of the increased amount of pattern recognition memory 44 that is available through PRS aggregation. Also shown is a communication link 1054 between the DPSC 1052 and the various PRS blocks (1056-1062). The link shown 1054 could be a high-speed data bus, data network, a series of dedicated data pathways, or other communication mechanism suitable for a particular application.

Referring to FIG. 23, a more detailed view 1080 of a typical multi-level distributed pattern recognition system is shown. In many ways the internal structure of the DPSC 1052 is similar to the PRC 20. A simple DPSC 1052 might provide an interface to an external host processor 12 via a series of I/O registers 1082. A control logic state machine 1084 might instruct a (potentially large) number of subordinate PRS computational subsystems (1056-1062) using the communications pathways shown collectively as 1096 to perform the bulk of the computational work involved in a very large pattern recognition operation. As each subordinate computational system (1056-1062) completes its assigned processing tasks it might report back to the DPSC result processing block 1086 with the results of its operation. The result processing block 1086 would coordinate with the control logic block 1084 to determine when all subordinate computational systems have completed their assigned tasks. Once all subordinate PRS subsystems have completed their tasks the final result processing block 1086 would perform whatever computations are necessary to develop a final mathematical result. Under the supervision of the control logic block 1084 the final result would be delivered by block 1086 to the search decision logic block 1088. Block 1088 would then perform any needed logical decisions, format results as needed, deliver the final pattern recognition search results to the I/O interface register block 1082, and instruct the control logic block 1084 to terminate the current search operation. It is currently envisioned that in a simple implementation an I/O interface register set very similar to 960 could be employed by a DPSC 1052.

The system view 1080 contemplates an environment where the number of subordinate PRS computational units (1056-1062) could be quite large. Given such an environment a single pattern recognition system could be constructed that employs hundreds or even thousands of PRS computational units (1056-1062) and thereby makes available hundreds of gigabytes of PRS pattern recognition database memory. Such a computational environment would provide the infrastructure to support extremely large pattern recognition databases. Pattern recognition databases containing millions or even billions of stored patterns could be employed while maintaining high computational speeds. Such systems could potentially exploit the pattern recognition concept of ‘exhaustive learning’ to great benefit.

Referring to FIG. 24, a high-level view 1120 of an efficiently connected multi-level distributed pattern recognition system is shown. Given an environment where a single pattern recognition system could be constructed that employs hundreds of PRS computational units (1056-1062), a means have effective connectivity between PRS units is contemplated. The connectivity scheme shown provides the basis for computations beyond RBF distance computations. Such computations might include additional feedback mechanisms between PRS computational units such that both feed-forward and back-propagation neural network computations could be effectively implemented. Additionally, improved cross-connectivity could provide an effective means to implement computational systems as illustrated by 1180 that extend beyond the domain of neural network computations or processing operations.

Referring to FIG. 26, a typical operational performance improvement resulting from a limited application of the computational acceleration methods of 630 is shown. The computation shown reflects a limited application of 4×32 parallelism and shows that roughly a 128-fold performance improvement can be anticipated. This illustrates the potential power of effective aggregation techniques.

Thus, while the preferred embodiments of the devices and methods have been described in reference to the environment in which they were developed, they are merely illustrative of the principles of the inventions. Other embodiments and configurations may be devised without departing from the spirit of the inventions and the scope of the appended claims.

I claim:

1. A pattern learning and recognition system comprising:
a computer having one or more large memories, a host processor, data input means and data output means;
one or more neural network processors connected to the host processor through an I/O bus;
one or more neuron memory arrays connected to each neural network processor using a dedicated bus, each neuron memory array containing a pattern recognition database in a plurality of neuron data blocks, each neuron data block containing a single feature vector.

2. A method of learning and recognizing patterns comprising the steps:
providing a computer having one or more large memories, a host processor, data input means and data output means;
attaching one or more neural network processors to the host processor through an I/O bus, the neural network processor processing data in a series of computation cycles;
attaching one or more neuron memory arrays to each neural network processor using a dedicated bus, each neuron memory array containing a pattern recognition database containing a plurality of neuron data blocks, each neuron data block containing a single feature vector;
processing pattern recognition data from two or more pattern recognition databases in each computation cycle of the neural network processor to provide a best match; and
reporting the best match with the data output means.
